(19) United States
(12) Patent Application Publication
(10) Pub. No.: US 2022/0161201 A1
(43) Pub. Date: May 26, 2022

(54) SYSTEMS, METHODS, AND MATERIALS FOR DETECTION AND REMOVAL OF HEAVY METALS FROM WATER

(71) Applicant: Matregenix, Inc., Irvine, CA (US)

(72) Inventors: Sherif Soliman, Irvine, CA (US); Feng Guo, Irvine, CA (US)

(73) Assignee: Matregenix, Inc., Irvine, CA (US)

(21) Appl. No.: 17/456,164

(22) Filed: Nov. 22, 2021

Related U.S. Application Data
(60) Provisional application No. 63/116,788, filed on Nov. 20, 2020.

(51) Int. Cl. B01D 69/02; C02F 1/00; B01D 69/12; B01D 67/00

(52) U.S. Cl. CPC B01D 69/02; C02F 1/001; C02F 2101/20; B01D 67/0093; B01D 69/12

(57) ABSTRACT

Electrospun poly(acrylic) acid (PAA)/poly(vinyl) alcohol PVA nanofibers and integrated filtration membranes generated therefrom are disclosed herein. The membranes are suitable for use in selectively removing heavy metals such as lead and cadmium from water. The surface of the nanofibers is preferably functionalized with one or more chelating agents. The membranes have a high removal efficiency and adsorption capacity with well-distributed hid-density heavy metal adsorption sites with strong binding affinities for targeted heavy metals.

### CROSS-REFERENCE TO RELATED APPLICATIONS

This application claims the benefit of, and priority to, U.S. Provisional Patent Application Ser. No. 63/116,788, filed on Nov. 20, 2020, the disclosure of which is hereby incorporated in its entirety herein by reference.

### BACKGROUND

### Field of the Invention

The present disclosure relates to systems and methods for systems and methods for the detection and removal of heavy metals from water.

### Description of the Related Art

Heavy metals such as lead (II), arsenic (III and IV), mercury (II), and cadmium (II)) are considered systemic toxicants that can induce organ damage, even at extremely low levels of exposure. See, e.g., Jaishankar, M., et al. “Toxicity, Mechanism and Health Effects of Some Heavy Metals,” Interdiscip. Toxicol. 2014, 7, 60-72; Podgorski, J. E., et al. “Extensive Arsenic Contamination in High-pH Unconfined Aquifers in the Indus Valley,” Sci. Adv. 2017 3, e1700935; Jan, A. T., et al. “Heavy Metals and Human Health: Mechanistic Insight into Toxicity and Counter Defense System of Antioxidants,” Int. J. Mol. Sci. 2015, 16, 29592-630. It has been estimated that over 1.1 billion people worldwide use unsafe water resources which may contaminated by heavy metals. See Fernandez-Luqueno, F., et al. “Heavy Metal Pollution in Drinking Water—A Global Risk far Human Health; A Review,” Afr. J. Environ. Sci. Technol. 2013, 7, 567-84. The Institute for Health Metrics and Evaluation (IHME) estimated that lead exposure accounted for 1.06 million deaths and a loss of 24.4 million disability-adjusted life years in 2017. See World Health Organization. “Lead Poisoning and Health,” available at www.who.int/en/news-room/fact-sheets/detail/lead-poisoning-and-health. A significant source of lead poisoning is lead-contaminated water sources. Id.

Removing toxic metals from aqueous solutions is often difficult due to their minimal biological degradability and high solubility. See, e.g., Barakat, M. “New Trends in Removing Heavy Metals from Industrial Wastewater,” Arab. J. Chem. 2011, 4, 361-77. A variety of approaches have been explored to remove toxic substances from water or utilize alternative water sources, including precipitation, flocculation, electrochemical technologies, ion exchange, and filtration. See, e.g., Gharabaghi. M., et al. “Selective Sulphide Precipitation of Heavy Metals from Acidic Polymetallic Aqueous Solution by Thioacetamide,” Ind. Eng. Chem. Res. 2012, 51, 954-63; Lin, Y.-F., et al. “Application of Bifunctional Magnetic Adsorbent to Adsorb Metal Cations and Anionic Dyes in Aqueous Solution,” J. Hazard. Mater, 2011, 185, 1124-30; Szygula, A., et al. “The Removal of Sulphonated Azo-Dyes by Coagulation with Chitosan. Colloids Surf A Physiochem. Eng. Asp 2008, 330, 219-26; Fu, F., et al. “Removal of Heavy Metal Ions from Wastewaters: A Review,” J. Environ, Manage, 2011, 92, 407-18; Cěrná, M. “Use of Solvent Extraction for the Removal of Heavy Metals from Liquid Wastes,” Environ. Monit. Assess. 1995, 34, 151-62; Hasan, S., et al. “Molecular and Ionic-Scale Chemical Mechanisms behind the Role of Nitrocyl Group in the Electrochemical Removal of Heavy Metals from Sludge,” Sci. Rep. 2016, 6, 31828; Vilensky, M. Y., et al, “in Situ Remediation of Groundwater Contaminated by Heavy- and Transition-Metal Ions by Selective Ion Exchange Methods, Environ. Sci. Technol. 2002, 36, 1851-55; Shaidan, N. H., et al, “Removal of Ni(II) Ions from Aqueous Solutions Using Fixed-Bed Ion Exchange Column Technique,” J. Taiwan Inst. Chem. Eng. 2012, 43, 40-45; Chan, B., et al., “Reverse Osmosis Removal of Arsenic Residues from Bioleaching of Refractory Gold Concentrates,” Miner. Eng. 2008, 21, 272-78; Hua, M., et al. “Heavy Metal Removal from Water/Wastewater by Nanosized Metal Oxides: A Review,” J. Hazard. Mater 2012, 211, 317-31; Shannon, M. A., et al. “Science and Technology for Water Purification in the Coming Decades,” Nature, 2008, 452, 301-10; Herrmann, S., el al. “Removal of Multiple Contaminants from Water by Polyoxometalate Supported Ionic Liquid Phases (POM-SILPs),”Angew. Chem. Int. Ed. Engl. 2017, 56, 1667-70.

These treatments, however, involve complicated processes and expensive instruments, making their deployment and widespread use challenging, especially in impoverished regions. See, e.g., Bhattarharya, K., et al. “Mesoporms Magnetic Secondary Nanostructures as Versatile Adsorbent for Efficient Scavenging of Heavy Metals,” Sci. Rep. 2015, 5, 17072; Li, B. et al, “Environmentally Friendly Chitosan/PEI-Grafted Magnetic Gelatin for the Highly Effective Removal of Heavy Metals from Drinking Water,” Sci. Rep. 2017, 7, 43082; Wang, Y., et at. “Rapid Removal of Pb(II) from Aqueous Solution Using Branched Polyethylenimine Enhanced Magnetic Carboxymethyl Chitosan Optimized with Response Surface Methodology,” Sci. Rep. 2017, 7, 10264; Alaaappan, P. N., et al. “Easily Regenerated Readily Deployable Absorbent for Heavy Metal Removal from Contaminated Water,” Sci. Rep. 2017, 7, 6682; Vojoudi, H., et al., “A New Nano-Sorbent for Fast and Efficient Removal of Heavy Metals from Aqueous Solutions Based on Modification of Magnetic Mesoporous Silica Nanospheres,” J. Magn. Magn. Mater. 2017, 441, 193-203.

Adsorption, on the other hand, has shown promise as a technique that provides operational flexibility, high removal efficiency, and low operating costs. However, most common adsorbents, including activated carbons, zeolites, and clays, lack strong binding affinities for metal ions. See, e.g., Kolodyńska, D., et at. “Comparison of Sorption and Desorption Studies of Heavy Metal Ions from Biochar and Commercial Active Carbon,” Chem. Eng. J. 2017, 307, 353-363, doi: 10.1016/j.cej.2016.08.088; Lu, X., et al. “Adsorption and Thermal Stabilization of Pb²⁺ and Cu²⁺ by Zeolite,” Ind Eng. Chem. Res. 2016, 55, 8767-73, doi: 10.1021/acs.iecr.6b00896; Seliman, A. F., et al. “Removal of Some Radionuclides from Contaminated Solution using Natural Clay; Bentonite,” J. Radioanal. Nucl. Chem. 2014, 300, 969-79, doi; 10.1007/s10967 -014-3027-z.

Thus, current commercialized adsorption systems cannot remove toxic metals effectively, with removal efficiencies of 6-35%. See, e.g., Li, B., et al., supra. In addition, the regeneration of sorbents for reuse remains challenging. See, e.g., Kongsricharoern, N., et al. “Chromium Removal by a Bipolar Electro-chemical Precipitation Process,” Water Sci. Technol. 1996, 34, 109-16; Yang, J., et at “High-Content, Well-Dispersed γ-Fe₂O₃ Nanoparticles Encapsulated in. Macroporous Silica with Superior Arsenic Removal Performance,” Adv. Funct. Mater. 2014, 24, 1354-63; Li, J., et at. “Magnetic Polydopamine Decorated with Mg—Al LDH Nanoflakes as a Navel Bio-based Adsorbent for Simultaneous “Removal of Potentially Toxic Metals and Anionic Dyes,” J. Mater. Chem. A, 2016, 4. 1737-46; Alagappan, P. N., et at., supra.

Nanomaterials have emerged as an effective adsorbent for heavy metal removal due to their abundant adsorption sites attributed to the high surface area to volume ratio of such material s. Alcaraz-Espinoza, J. J., et all. “Hierarchical ° site Polyaniline-(Electrospun Polystyrene) Fibers Applied to Heavy Metal Remediation,” ACS Appl. Mater. Interfaces, 2015, 7 7231-40. Among nanomaterials, nanofibers are readily handled as a bulk material and are thus the most promising adsorbent for heavy metal removal.

Electrospinning is a promising method of developing nanofibrous adsorbents. Use of electrospinning to generate nanofiber membranes provides efficiency and uniformity of pore size. See, e.g., Ray, S. S., et al. “A Comprehensive Review: Electrospinning Technique for Fabrication and Surface Modification of Membranes fbr Water Treatment Application,” RSC Adv. 2016, 6(88), 85495-85514, doi: 10.1039/C6RA14952A. Electrospinning is a process that uses an electric field to generate continuous fibers on a micrometer or nanometer scale. Electrospinning enables direct control of the microstructure of the fibers generated thereby, including characteristics such as the fiber diameter, orientation, pore size, and porosity.

Electrospun composite polymer nanoliters exhibit several essential characteristics such as large surface areas and small pore sizes with high porosity to provide a fine filtration structure and excellent adsorption performance for heavy metal removal. See, e.g., Zhang, S., et al. “Lead and Cadmium Adsorption by Electrospun PVA/PAA Nanofibers: Batch, Spectroscopic, and Modeling Study,” Chemosphere, 2019, 233, 405-13; Zhang, S., et al. “Adsorptive Filtration of Lead by Electrospun PVA/PAA Nanofiber Membranes in a Fixed-bed Column,” Chem. Eng. J. 2019, 370, 1262-73; Foong, C. Y. et al. “A Review on Nanofibers Membrane with Amino-based Ionic Liquid for Heavy Metal Removal,”J. Mol. Liq. 2019, 111793; Zhang, S., et al. “Chromate Removal by Electrospun PVA/PEI Nanofibers: Adsorption, Reduction, and Effects of Co-existing Eons,” Chem. Eng. J. 2020, 387, 124179 Hu, Y. et all. “Phosphorylated Polyacrylonitrile-based Electrospun Nanofibers for Removal of Heavy Metal. Ions from Aqueous Solution,” Polym. Adv. Technol. 2019, 30, 545-51; Hamad, A. A., et al. “Electrospun Cellulose Acetate Nanofiber Incorporated with Hydroxyapatite for Removal of Heavy Metals,” Int. J. Biol. Macromol. 2.020, 151, 1299-313, doi: 10 .1016/j.ijbiomac.2019.10.1 6; Karim, M. R., et al. “Composite Nanofibers Membranes of Poly(vinyl alcohol)/Chitosan for Selective Lead (II) and Cadmium (II) Ions Removal from Wastewater,” Ecotoxecol. Environ, Saf. 2019, 169, 479-86.

Heavy metal ion removal using electrospun nanofiber membranes results from interactions between the functional sites on the nanofiber surface and the heavy metal ions. This interaction can be physical, such as affinity or electrostatic interactions, or chemical, such chelation or coordination complex formation. Therefore, incorporating suitable surface functional groups into the nanofibrous membrane will increase the efficiency of heavy metal ion removal. See, e.g., Gao, M., et of. “Polymer-metal-organic Framework Core-shell Framework Nanofibers via Electrospinning and Their Gas Adsorption Activities,” RSC Adv. 2016, 6, 7078-85; Kayaci, F., et al. “Surface Modification of Electrospun Polyester Nanofibers with Cyclodextrin Polymer for the Removal of Phenanthrene from Aqueous Solution,” J. Hazard. Mater. 2013, 261, 286-94.

There remains a need for next-generation, inexpensive, recyclable nanofiber membranes with well-distributed high-density adsorption sites with strong binding affinities for use as adsorbents for removal of heavy metals from water.

### SUMMARY

Electrospun poly(acrylic) acid (PAA)/poly(vinyl) alcohol PVA nanofibers and integrated filtration membranes generated therefrom are disclosed herein. The membranes are suitable for use in selectively removing heavy metals such as lead and cadmium from water. The surface of the nanofibers is preferably functionalized with one or more chelating agents. The membranes have a high removal efficiency and adsorption capacity with well-distributed high-density heavy metal adsorption sites with strong binding affinities for targeted heavy metals.

### DETAILED DESCRIPTION

Electrospun poly(acrylic) acid (PAA)/poly(vinyl) alcohol PVA nanofibers and integrated filtration membranes generated therefrom are disclosed herein. The membranes are suitable for use in selectively removing heavy metals such as lead and cadmium from water. The membranes have a high removal efficiency and adsorption capacity with well-distributed high-density heavy metal adsorption sites with strong binding affinities for targeted heavy metals.

PAA is an effective material because it has abundant carboxyl groups, which provide a sufficient number of adsorption sites for heavy metals. The addition of PVA improves the water stability of the nanofibers, See Park, J.-C., el at. “Electrospun Poly(vinyl alcohol) Nanofibers: Effects of Degree of Hydrolysis and Enhanced Water Stability,” Polym, J. 2010, 42, 273-76. The PVA/PAA nanofibers have excellent water stability, mechanical properties, and water permeability.

In some embodiments, the water stability of the PVA/PAA nanofibers is achieved via crosslinking of PVA and PAA within the nanofibers.

The surface of the nanofibers may preferably be functionalized with one or more chelating agents. The chelating agent may be one or more chelating agents selected from the group consisting of ethylenediamine and ethylenediaminetetraacetic acid (EDTA).

The surface-functionalized nanofiber membranes preferably include a sufficient number of heavy metal bonding sites to rapidly remove heavy metals from water and reduce the concentration of targeted heavy metals in the treated water below designated limits. Membranes generated from the surface-functionalized nanofibers may preferably remove targeted heavy metals from 1-10 ppm in water to below limits prescribed by the U.S. Environmental Protection Agency (EPA) as of the filing date of the present application with an empty bed contact time (EBCT) of less than 5 minutes.

In some embodiments, the membrane may be regenerated after being used to remove heavy metals from water. Adsorbed heavy metals may be desorbed from the membrane using a suitable regeneration solution. The regeneration solution may include EDTA, as EDTA is known to be able to desorb heavy metals from chelation sites, See, e.g., Wang, Y. et al., supra; Peng, Y. et al. “A Versatile MOF-based Trap for Heavy Metal Ion Capture and Dispersion,” Nat. Commun. 2018, 9, 187. The regeneration solution may, for example, comprise aqueous EDTA and hydroxide. In some embodiments, the regeneration solution comprises 0.1 M EDTA-Na and 0.1 M NaOH.

Methods of using the disclosed membranes to remove heavy metals from water are also disclosed herein. The membranes may be used to remove lead, cadmium, or other heavy metals from water.

### EXAMPLE

The following example is provided as a specific illustration. It should be understood, however, that the invention is not limited to the specific details set forth in the example. All parts and percentages in the example, as well as in the remainder of the disclosure, are by weight unless otherwise specified.

Further, any range of numbers recited above or in the paragraphs hereinafter describing or claiming various aspects of the invention, such as ranges that represent a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for or in conjunction with a variable, is intended to convey that the numbers and ranges disclosed herein may be flexible as understood by ordinarily skilled artisans and that practice of the disclosed invention by those skilled in the art using temperatures, concentrations, amounts, contents, carbon numbers, and properties that are outside of a literal range will achieve the desired result, namely, surface-functionalized PAA/PVA nanofiber materials and systems and methods for removal of heavy metals from water using integrated filtration membranes formed from said surface-functionalized PAA/PVA nanofiber materials.

### Preparation of PAA/PVA Nanofibers

A PAA/PVA polymer solution is prepared by mixing three solutions (PAA: PVA: deionized water) to generate a mixed polymer solution of 10 wt % (5 wt % PAA, wt % PVA). The mixed polymer solution is stirred for 1 h to generate a homogeneous solution. Electrospun PAA/PVA nanofibers are then generated using an electrospinning apparatus. The applied voltage is 40 kV and the flow rate of the PAA/PVA solution is 22 mL/h. The nanofibrous membranes are deposited on a PET roll, which is rolling with a winding speed of 0.6 m/h. The electrospun nanofibrous membranes are then heat-treated at 145° C. for 30 min to impart water stability through crosslinking.

Chelating agents that enhance the affinity of heavy metals to the surface of the nanofibers are loaded during the electrospinning process by blending into the polymer solution or alternatively by physically coating the chelating agents on the surface of the nanofibers using vapor deposition such as chemical vapor deposition (CVD) or physical vapor deposition (PVD).

### Analysis of Morphology, Water-Stability, Porosity and Water Permeability

The morphology of the surface and cross-section of nanofiber membranes is evaluated by scanning electron microscope (SEM). Specimens used for cross-sectional imaging are frozen and cracked in liquid nitrogen and then coated with gold. The fiber diameter is averaged by selecting 40 fibers in the SEM images. The variability in fiber diameter may be attributed to variability in the PAA content of the polymer solution. It is observed that increased PAA content results in increased average nanofiber diameter.

The porosity of crosslinked PVA/PAA nanofibers is calculated using Eq. 1:

$$p = ( 1 - \frac{ρ}{{ρ}_{0}} ) \times 100 \qquad ( 1 )$$

where ρ is the fiber density (mass/volume for regularly-shaped fiber membranes) and ρₐ is the density of the PVA/PAA polymer mixture. ρ₀ is calculated using Eq. 2.

$$\frac{1}{{ρ}_{0}} = \frac{ω1 \%}{{ρ}_{1}} + \frac{ω2 \%}{{ρ}_{2}} \qquad ( 2 )$$

The thickness of all the nanofibers samples is approximately 30 μm. The densities of the pre-blended PVA and PAA polymers are calculated using a PVA polymer density of 1.25 g/m³ and a PAA polymer density of 1.44 g/m³, as provided in polymerdatabase.com. The porosity is found to decrease with increased fiber density. Water stability is evaluated by averaged swelling degree

$$( S = \frac{{W}_{s} - {W}_{d}}{{W}_{d}} ,$$

where W_{d} and Wₛ are the mass of fibers before and after immersing in deionized water for 48 h). The results obtained show a low averaged swelling degree, as compared to the averaged swelling degree of 9.69 for previously reported systems. See \textcircled{C}erná, M. et al., supra. The results show improved water stability after crosslinking for 2 h as compared to crosslinking for 0.5 h. In addition, the water flux does not change over 72 h continuous flow, which also demonstrates the stability of the membranes and their compatibility with water.

### Evaluation of Heavy Metal Adsorption

Heavy metals removal efficiency is evaluated for surface-functionalized nanofibers by conducting batch adsorption studies. The concentration of the heavy metals is measured using inductively coupled plasma mass spectrometry (ICP-MS).

The previous description of the disclosed embodiments is provided to enable any person skilled in the art to make or use the invention disclosed herein. Although the various inventive aspects are disclosed in the context of one or more illustrated embodiments, implementations, and examples, it should be understood by those skilled in the art that the invention extends beyond the specifically disclosed embodiments to other alternative embodiments and or uses of the invention and obvious modifications and equivalents thereof. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope a the disclosure. Thus, the present disclosure is not intended to be limited to the embodiments shown herein but is to be accorded the widest scope consistent with the principles and novel features disclosed herein.

All references cited are hereby expressly incorporated herein by reference.

What is claimed is:

1. A membrane comprising nanofibers comprising:
a. poly(acrylic) acid; and
b. poly(vinyl) alcohol;
wherein the membrane is generated by electrospinning of a polymer solution;
wherein the membrane is functionalized with one or more chelating agents; and
wherein the membrane is suitable for use in selectively removing heavy metals from water.

2. The membrane of claim 1, wherein the one or more cheating agents are selected from the group consisting of ethylenediamine and ethylenediaminetetraacetic acid.

3. The membrane of claim 2, wherein the one or more chelating agents include ethylenediamine.

4. The membrane of claim 2, wherein the one or more chelating agents include ethylenediaminetetraacetic acid.

5. The membrane of claim 1, wherein the poly(acrylic) acid and poly(vinyl) alcohol are crosslinked.

6. The membrane of claim 2, wherein the poly(acrylic) acid and poly(vinyl) alcohol are crosslinked.

7. The membrane of claim 1, wherein the one or more chelating agents are blended into the polymer solution during electrospinning.

8. The membrane of claim 2, wherein the one or more chelating agents are blended into the polymer solution during electrospinning.

9. The membrane of claim 1, wherein the one or more cheating agents are physically coated onto the surface of the nanofibers.

10. The membrane of claim 2, wherein the one or more chelating agents are physically coated onto the surface of the nanofibers.

11. The membrane of claim 1, wherein the membrane is capable of being regenerated after being used to remove heavy metals from water.

12. The membrane of claim 2, wherein the membrane is capable of being regenerated after being used to remove heavy metals from water.

13. A method of removing heavy moats from water comprising using the membrane of claim 1 to remove heavy metals from water.
